(19) United States
(12) Patent Application Publication
(10) Pub. No.: US 2024/0215621 A1
(43) Pub. Date: Jul. 4, 2024

(54) HYDRATION COMPOSITION, METHOD OF MANUFACTURE THEREOF AND ARTICLES COMPRISING THE SAME

(71) Applicant: Ripplewell, Inc., Thousand Oaks, CA (US)

(72) Inventor: Lanie Yeung, Thousand Oaks, CA (US)

(21) Appl. No.: 18/403,184

(22) Filed: Jan. 3, 2024

Related U.S. Application Data
(60) Provisional application No. 63/436,985, filed on Jan. 4, 2023.

(51) Int. Cl. A23L 21/12; A23L 21/15; A23L 29/231; A23L 29/244; A23L 29/269

(52) U.S. Cl. CPC A23L 21/12; A23L 21/15; A23L 29/231; A23L 29/244; A23L 29/27

(57) ABSTRACT

Disclosed herein is a hydration composition comprising water; a gelling agent; and

fruit or vegetable puree having a particle size of 50 nanometers to 0.5 millimeters and/or fruit or vegetable particles having a particle size of 4 millimeters to 15 millimeters. Disclosed herein too is a method comprising mixing together a hydration composition comprising water; a gelling agent; and fruit or vegetable puree having a particle size of 50 nanometers to 0.5 millimeters and/or fruit or vegetable particles having a particle size of 4 millimeters to 15 millimeters; and gelling the hydration composition to form a gelled composition.

### CROSS-REFERENCE TO RELATED APPLICATION

This application claims the benefit of U.S. Provisional Patent Application Ser. No. 63/436,985 filed Jan. 4, 2023. The related application is incorporated herein in its entirety by reference.

### BACKGROUND

Disclosed herein is a hydration composition, methods of manufacture thereof and articles comprising the same.

Electrolyte solutions are conventionally used to orally replace electrolytes lost during vomiting, diarrhea, or exercise. Electrolyte loss through diarrhea and vomiting in particular can cause adverse health outcomes associated with dehydration, especially in infants, young children and older adults. These outcomes include delirium, infections, heat stress, falls, poor wound healing and seizures. For many young children and older adults, it is difficult to orally rehydrate adequately and replace electrolyte loss. Alternatively, intravenous rehydration is available, however, requires administration, monitoring from a healthcare professional, and poses a risk for infection. It is therefore desirable to compensate for electrolyte loss using other methods of replacement.

### SUMMARY

Disclosed herein is a hydration composition comprising water; a gelling agent; and fruit or vegetable puree having a particle size of 50 nanometers to 0.5 millimeters and/or fruit or vegetable particles having a particle size of 4 millimeters to 15 millimeters.

Disclosed herein too is a method comprising mixing together a hydration composition comprising water; a gelling agent; and fruit or vegetable puree having a particle size of 50 nanometers to 0.5 millimeters and/or fruit or vegetable particles having a particle size of 4 millimeters to 15 millimeters; and gelling the hydration composition to form a gelled composition.

### DETAILED DESCRIPTION

Disclosed herein is a composition that may be orally consumed to provide a living being with water and added functional ingredients, such as electrolytes. In an embodiment, the composition is in the form of a gel that may be consumed orally and delivers water and electrolytes to the body of the living being. The composition comprises over 75 wt % of water, gelling agents and natural flavors, based on the total weight of the composition.

The water serves to solubilize and hydrate some of the other components of the composition and also functions to provide hydration to the patient when it is orally imbibed and ingested. The water facilitates uniform homogenization of the ingredients present in the composition. In an embodiment, the composition comprises greater than or equal to 80 wt % water, greater than or equal to 85 wt % water, greater than or equal to 90 wt % water, and preferably greater than or equal to 95 wt % water, based on the total weight of the composition. The water is preferably distilled or deionized. The water has a pH of 7 to 7.5.

The gelling agent used in the aqueous phase of the emulsion may be any physiologically tolerable gelling agent. In an embodiment, the gelling agent is preferably a saccharide (e.g., an oligosaccharide or polysaccharide), a protein or a glycoprotein, or combination thereof that is capable of forming a soft, chewable, self-supporting gelled composition. Many such materials are known GRAS (Generally Recognized As Safe) ingredients from the food and pharmaceutical industry and are discussed for example in Handbook of hydrocolloids, G O Phillips and P A Williams (Eds.), Woodhead Publishing, Cambridge, UK, 2000. The gelling agents are preferably materials capable of undergoing a sol-gel transformation, e.g., under the influence of a change in physicochemical parameters such as temperature, pH, presence of metal ions (e.g., group 1 or 2 metal ions), and the like.

Examples of gelling agents include gelatin, alginate, carrageenan, oligosaccharides, polysaccharides, hydrocolloids, pectin, starch, or a combination thereof. Examples of gelling agents added to the composition are hydrocolloids, examples of which are vegetable gums, a pectin blend that includes one or more of konjac, xanthan gum, pectin, gellan gum, locust bean gum, citrus fiber, and/or agar in combination with mineral based initiators in some cases. Examples of other gelling agents that may be used include guar gum, psyllium seed gum, yam, seaweed flour, tragacanth gum, karaya gum, curdlan, soy polysaccharides, alginic acid, carboxymethylcellulose, arabinoxylan, arrowroot, cassia gum, cellulose, gum Arabic, kuzu, maltodextrin, marshmallow root, sodium alginate, b-glucan, and the like, or a combination thereof.

In a preferred embodiment, the gelling agent includes one or more of a vegetable gum, pectin, konjac, xanthan gum, gellan gum, locust bean gum, agar agar, yam starch, and the like, or a combination thereof. In an embodiment, the gelling agent comprises konjac, xanthan gum and pectin.

The gelling agent is preferably in the form of a dry powder prior to blending with the water and is added in an amount of 0.5 to 3 wt %, preferably 1 to 2 wt %, based on the total weight of the composition. The gelling agent is typically added at a pH of 5.0 to 7.5 when solubilized in water before adjusting pH.

The gelling agent varies inversely with the amount of fruit and/or vegetable puree (small sized particles) or the amount of fruit and/or vegetable particles (large sized particles).

The composition may optionally comprise a sweetener. Sweeteners include allulose or erythritol, other sugar alcohols such as, maltitol, sorbitol, mannitol, isomalt, xylitol, or a combination thereof. Other sugars that may be added include sucrose, fructose, high fructose corn, dextrose, sucralose, cane sugar, brown sugar, yacon syrup, maple, agave, saccharine, neotame, date, fruit and vegetable juice and concentrates, juice concentrates, isomaltooligosaccharides (e.g., isomaltose, panose, isomaltotriose, isomaltotetraose, isomaltopentaose, nigerose, kojibiose, and higher branched oligosaccharides), and the like, or a combination thereof. Juice concentrates include fruit and vegetable juices and their concentrates.

Fruits (that may be used in puree, juice or concentrate form) include mangoes, guava, peaches, berries (strawberries, blackberries, blueberries, raspberries, cranberries, elderberries, chokecherries, chokeberries, and the like), pineapples, bananas, citrus (orange, lemon, lime, yuzu, and the like), melon (watermelon, cantaloupe, honey dew, and the like), cherries, pears, apples, grapes, coconuts, avocados, acai, figs, lychee, dates, camu, mangosteen, pomegranate, jujube, and the like, or a combination thereof. Vegetables (that may be used in puree, juice or concentrate form) include cucumbers, sweet potato, butternut squash, potato, carrot, pumpkin, spinach, kale, broccoli, beets, bok choy, cauliflower, peas, zucchini, mushroom, legumes (e.g., black, garbanzo, navy, pinto, red, or a combination thereof), and the like, or a combination thereof.

The sweeteners may be added in the form of a syrup or a dry powder and is present in the composition prior to mixing in an amount of 5 to 10 wt %, 2 to 5 wt %, based on the weight of the composition prior to mixing. The pH is typically 3 to 7 in an aqueous solution before adjusting pH. Examples of these sweeteners are allulose, erythritol, or the like, or a combination thereof.

Other sweeteners may further optionally include high-intensity sweetener blends. The high intensity sweetener blends may include stevia, monk fruit, sucralose, thaumatin, aspartame, maltodextrin, and the like, or a combination thereof. The high intensity sweetener may be added in amounts of 0.01 to 0.2 wt % in final wet weight gel solution. In an embodiment, the high intensity sweetener may be added in an amount of up to 1 wt %, prior to mixing.

The composition may also include soluble and/or insoluble fiber. The composition may include soluble fiber in the form of tapioca, inulin oligofructose, mucilage, beta-glucans, polydextrose polyols, psyllium, resistant starch, wheat dextrin, corn fiber, or a combination thereof. Insoluble fibers may also optionally be added to the composition. Examples of insoluble fibers include wheat bran, vegetable fibers, whole grain fibers, cellulose, lignin, some hemicellulose, or a combination thereof.

The soluble and/or insoluble fiber is added in an amount of 0.5 to 8 wt %, 1 to 5 wt %, based on the weight of the composition.

Other functional ingredients such as vitamins, minerals, herbs, botanicals, spices, amino acids, functional whole food ingredients, grains, enzymes, nutraceuticals, OTC (over the counter) medicinal, drugs and antioxidants may also optionally be added to the composition.

In an embodiment one functional ingredient that may be added to the composition includes fruit and/or vegetable puree. Examples of fruits include mangoes, guava, peaches, berries (strawberries, blackberries, blueberries, raspberries, cranberries, elderberries, chokecherries, chokeberries and the like), pineapples, bananas, citrus (orange, lemon, lime, yuzu, and the like), melon (watermelon, cantaloupe, honey dew, and the like), cherries, pears, apples, grapes, coconuts, avocados, acai, figs, lychee, dates, camu camu, mangosteen, pomegranate, jujube, and the like, or a combination thereof. Vegetables (that may be used in puree form) include cucumbers, sweet potato, butternut squash, potato, carrot, pumpkin, spinach, kale, broccoli, beets, bok choy, cauliflower, peas, zucchini, mushrooms, legumes (e.g., black, garbanzo, navy, pinto, red, or a combination thereof), and the like, or a combination thereof.

The fruit and/or vegetable puree may include fruit and vegetable pulp in the form of small sized particles of size 50 nanometers to 0.5 millimeters, preferably 100 nanometers to 0.25 millimeters, and more preferably 500 nanometers to 0.1 millimeters. In another embodiment, the fruit and/or vegetable puree may include fruit and vegetable pieces in the form of large sized particles of size 4 millimeters to 15 millimeters, preferably 4 to 12 millimeters, and more preferably 6 to 10 millimeters. In an embodiment, the fruit and/or vegetable puree may include both fruit and vegetable puree as well as fruit and vegetable pieces. The fruit and/or vegetable puree (without the fruit and/or vegetable particles) may be present in an amount of 1 to 20 wt %, preferably 2 to 15 wt %, based on the total weight of the composition prior to mixing. In another embodiment, the fruit and/or vegetable particles (without the fruit and/or vegetable puree) may be present in an amount of 1 to 20 wt %, preferably 2 to 15 wt %, based on the total weight of the composition prior to mixing. In an embodiment, when both the puree and the particles are used together in the composition, both the puree and the particles may be present in a total amount of 1 to 20 wt %, preferably 2 to 15 wt %, based on the total weight of the composition prior to mixing.

Minerals and electrolytes are present in the composition in order to replenish these components in the body of the living being. Suitable salts for use in the electrolyte composition includes salts of metals such as sodium, potassium, zinc, magnesium, selenium, or a combination thereof. The salts can include carbonates, potassium, chlorides, nitrates, citrates, sulfates, sulfites, (sensitizing agents) acetates or oxides of the foregoing metals.

Fluids that can impart ionic charges to the composition may be used. Sea water, coconut water, milk, and the like, may be used to impart ionic charges to the composition if desired.

In an embodiment, the composition comprises electrolyte composition comprising:
(a) from about 50 to 99 wt %, preferably 70 to about 97 percent by weight water, preferably 82 to 95 wt %, and more preferably 85 to 90 wt %;
(b) from about 20 to about 60 mEq of sodium per liter of water;
(c) from about 15 to about 25 mEq of potassium per liter of water;
(d) from about 25 to about 50 mEq of chloride per liter of water;
(e) from about 20 to about 50 mEq of citrate per liter of water;
(f) from about 20 to about 30 grams of carbohydrate per liter of water; and
(g) fruit puree in an amount of 1 to 20 wt %, based on the total weight of the composition after mixing.

It is to be noted that water can be added in its pure form (as deionized water) or alternatively derived from other fluids such as coconut water, milk, plant milk, nut milk, fruit juice, vegetable juice and the like. In an embodiment, the electrolytes may be coated on the fruit and/or vegetable puree (e.g., the small sized particles) or on the fruit and/or vegetable particles (e.g., the large sized particles) to form a concentrate or a crust that is rich in electrolytes.

The composition may further comprise optional additives such as proteins, nutrients, vitamins, prebiotics, probiotics, postbiotics, caffeine, nootropics, adaptogens, herbs, spices, pharmaceuticals and biologically active agents, and the like, or a combination thereof. The optional additives listed below may be added in amounts of up to 0.25 to 5 wt %, 0.1 to 4.5 wt % each, when present.

Proteins include (amino-acids, plant-based, animal-based), collagen, creatine, creatine monohydrate, whey-isolate, L-Aspartic Acid, L-Valine, L-Serine, L-Threonine, L-Tyrosine, L-Phenyalanine, L-Theanine, and the like, or a combination thereof.

Nutrients, whole food ingredients, and vitamins include Vitamin C, Vitamin D, Vitamin B, niacin, folic acid, DHA, melatonin, biotin, iron, flaxseed, chia seeds, green tea, magnesium, zinc, carotenoids, coenzyme Q10, and the like, or a combination thereof.

Nootropics include ashwagandha, ginseng, lion's mane, Ginkgo biloba, gamma aminobutyric acid, CDP-choline, huperzine A, vinpocetine, Bacopa monnieri, Rhodiola rosea, panax vinseng, nicotine, noopept, racetam, piracetam, phenotropil, modafinil, or a combination thereof.

Herbs and spices include turmeric, curcumin, rhodiola, triphala, brahmi, gota kola, bitter melon, cardamom, cinnamon, sage, peppermint, holy basil, capsaicin, ginger, fenugreek, rosemary, garlic, rhubarb, nutmeg, cubeb, angelica root, dong quai, snow fungus, or a combination thereof.

Pharmaceuticals and biologically active agents include anti-analgesic agents, anti-arrhythmic agents, anti-bacterial agents, anti-cholinergic agents, anti-coagulant agents, anti-convulsant agents, anti-depressant agents, anti-diabetic agents, anti-diuretic agents, anti-fungal agents, anti-hypertensive agents, anti-inflammatory agents, anti-malarial agents, anti-neoplastic agents, anti-nootropic agents, anti-Alzheimer's agents, anti-Parkinson agents, anti-retroviral agents, anti-tuberculosis agents, anti-tussive agents, anti-ulcerative agents, anti-viral agents, or the like, or a combination comprising at least one of the foregoing therapeutic and pharmaceutically biologically active agents.

Examples of other suitable therapeutic and pharmaceutically biologically active agents are anti-proliferative/antimitotic agents including natural products such as vinca alkaloids (e.g., vinblastine, vincristine, and vinorelbine), paclitaxel, epidipodophyllotoxins (e.g., etoposide, teniposide), antibiotics (e.g., dactinomycin, actinomycin D, daunorubicin, doxorubicin, penicillin V, penicillin G, ampicillin, amoxicillin, cephalosporin, tetracycline, doxycycline, minocycline, demeclocycline, erythromycin, aminoglycoside antibiotics, polypeptide antibiotics, nystatin, griseofulvin, and idarubicin), anthracyclines, mitoxantrone, bleomycins, plicamycin, mithramycin and mitomycin, enzymes (L-asparaginase, which systemically metabolizes L-asparagine and deprives cells which do not have the capacity to synthesize their own asparagine), antiplatelet agents such as G (GP) Iib/IIIa inhibitors and vitronectin receptor antagonists, anti-proliferative/antimitotic alkylating agents such as nitrogen mustards (e.g., mechlorethamine, cyclophosphamide and analogs, melphalan, chlorambucil), ethylenimines and methylmelamines (e.g., hexamethylmelamine and thiotepa), alkyl sulfonates-busulfan, nitrosoureas (e.g., carmustine (BCNU) and analogs, streptozocin), trazenes-dacarbazinine (DTIC), anti-proliferative/antimitotic antimetabolites such as folic acid analogs (e.g., methotrexate), pyrimidine analogs (e.g., fluorouracil, floxuridine, cytarabine), purine analogs and related inhibitors (e.g., mercaptopurine, thioguanine, pentostatin and 2-chlorodeoxyadenosine {cladribine}), platinum coordination complexes (e.g., cisplatin, carboplatin), procarbazine, hydroxyurea, mitotane, aminoglutethimide, hormones (e.g., estrogen), anti-coagulants (e.g., heparin, synthetic heparin salts and other inhibitors of thrombin), fibrinolytic agents (e.g., tissue plasminogen activator, streptokinase and urokinase), aspirin, dipyridamole, ticlopidine, clopidogrel, abciximab, antimigratory, antisecretory (e.g., breveldin), anti-inflammatory: such as adrenocortical steroids (e.g., cortisol, cortisone, fludrocortisone, prednisone, prednisolone, 6α-methylprednisolone, triamcinolone, betamethasone, and dexamethasone), non-steroidal agents (e.g., salicylic acid derivatives such as aspirin, para-aminophenol derivatives such as hodiola, phen, indole and indene acetic acids (e.g., indomethacin, sulindac, etodalac), heteroaryl acetic acids (e.g., tolmetin, diclofenac, ketorolac), arylpropionic acids (e.g., ibuprofen and derivatives), anthranilic acids (e.g., mefenamic acid, meclofenamic acid), enolic acids (e.g., piroxicam, tenoxicam, phenylbutazone, oxyphenthatrazone), nabumetone, gold compounds (e.g., auranofin, aurothioglucose, gold sodium thiomalate), immunosuppressives (e.g., cyclosporine, tacrolimus (FK-506), sirolimus (e.g., rapamycin, azathioprine, mycophenolate mofetil), angiogenic agents such as vascular endothelial growth factor (VEGF), fibroblast growth factor (FGF), angiotensin receptor blockers, nitric oxide donors, anti-sense oligionucleotides and combinations thereof, cell cycle inhibitors, mTOR inhibitors, and growth factor receptor signal transduction kinase inhibitors, retenoids, cyclin/CDK inhibitors, HMG co-enzyme reductase inhibitors (statins) or protease inhibitors, flu/cough/cold medication and pain medication (e.g., acetaminophen, ibuprofen, and paracetamol), cough suppressants such as dextromethorphan (Robitussin)) and antihistamines (e.g., loratadine), oral covid vaccine, lecanemab (for treating Alzheimer's disease), or a combination thereof.

Psychedelics may also be added to the hydration composition. Psychedelics (also known as hallucinogens) are a class of psychoactive substances that produce changes in perception, mood and cognitive processes. Psychedelics affect all the senses, altering a person's thinking, sense of time and emotions. There are many different kinds of psychedelics. Some occur naturally, in trees, vines, seeds, fungi and leaves. Others are made in laboratories. They come in many forms including tablets, blotter paper, dried mushrooms, powders and crystalline powders. Examples of psychedelics include psilocybin, methylenedioxymethamphetamine (MDMA), marijuana, ketamine, fluoxetine, hodiola, hodiol, steroids, testosterone, hodi, valium, ambien, tramadol, codeine, and the like, or a combination thereof.

Nootropics and “smart drugs” such as CDP-choline, huperzine A, vinpocetine, Bacopa monnieri, hodiola rosea, panax vinseng, nicotine, noopept, racetam, piracetam, phenotropil, modafinil (can be used as prescription drug to treat narcolepsy), turkey tail, and the like, or a combination thereof, may also be added to the composition.

In one embodiment, in one manner of manufacturing the hydration composition, the gelling agent, water, the puree and other desirable ingredients may be poured into a container and mixed for a desirable period of time. The temperature of the mixture may be elevated to facilitate dissolution of the ingredients in water if desired. The mixing is conducted until the ingredients dissolve and the solution reaches a desirable viscosity and homogenous blend. During the mixing, it is desirable to preserve as much water as possible in the hydration composition. The hydration composition, upon reaching the desirable viscosity, is termed the gelled composition. The gelled composition is then poured into a mold (having desired shapes) or alternatively, poured onto a surface to form a sheet and allowed to cool. Desirable shapes are obtained from the mold or alternatively cut from the sheet using a cutting tool. The shapes are then suitably packaged, if not deposited directly into desired packaging. Alternatively, the gelled composition is deposited directly into a package made of film, foil, plastic or plastic resin bag-like, pouch-like, sachet-like, or stickpack-like, or tray-like container.

It is to be noted that after gelation, the composition is in the form of a dimensionally stable shape and has a water content of greater than or equal about 90 wt %, preferably greater than or equal to about 96 wt %, and more preferably greater than or equal to about 98 wt %, based on the gelled composition.

The hydration composition after gelation has a pH between 2 and 9, preferably between 3 and 8, and more preferably between 3.4 and 4.1.

In an embodiment, the composition after gelation may be coated with a crust of a functional ingredient and/or a flavorant. The functional ingredient may include proteins, nutrients, vitamins, prebiotics, probiotics, postbiotics, caffeine, nootropics, adaptogens, herbs, spices, pharmaceuticals and biologically active agents, and the like, or a combination thereof. In another embodiment, the functional ingredient and/or flavorant may be concentrated and added in the form of discrete particles to the composition. The discrete particles may be disposed on a surface of the composition or may be dispersed in the bulk of the composition, or be both disposed on the surface of the composition and dispersed in the bulk of the composition.

The hydration composition and the method of manufacturing are exemplified by the following non-limiting example.

### EXAMPLE

This example is conducted to demonstrate the ingredients used in an exemplary composition. The composition is detailed in the Table 1, while the method of manufacturing is detailed in the Table 2. Table 2 depicts an exemplary method of manufacturing the composition in the Table 1.

TABLE 1

| | | | | Percent by |
|---|---|---|---|---|
| | Ingredient | Descriptors | pH | Weight |
| 1 | Allulose or erythritol | Dry Powder or Syrup | 3.0-7.0 | 0-5% |
| 2 | Vegetable Gum, Pectin Blend | Dry Powder | 5.0-7.5 | 0.5-3% |
| | Konjac, Xanthan, Pectin, Locust | | | |
| | Bean and/or Agar, Yam Starch | | | |
| 3 | High Intensity Sweetener | Natural | 4.0-7.0 | 0.01-1% |
| | Blend | | | |
| 4 | Soluble Fiber | Syrup | 3.5-5.5 | 0.0-5% |
| 5 | Water | Distilled | 7.0-7.5 | 75-80% |
| 6 | Fruit Juice, Fruit Concentrate | Single Strength | 3.3-4.5 | 1-20% |
| | and/or Puree Blend | | | |
| 7 | Acid Blend (includes Ascorbic) | Dry Powder | 1.0-2.5 | 0.25-0.7% |
| 8 | Salt | Powder | 7.0-8.6 | 0.01-2.5% |
| 9 | Natural Color(s) and Flavor(s) | Dry or liquid - Plant Based, | NA | 0.5-1.5% |
| | | Oil or Water Based Flavor | | |
| 10 | Preservative Natural Sorbic Acid | Dry Powder with Carrier - | | 0.0-0.3% |
| | | Plant Based | | |
| 11 | Oil | Oil | | 0.00-0.2% |

TABLE 2

| | |
|---|---|
| 1 | Blend dry ingredients - bulking agents, gums, and sweeteners |
| 2 | Blend dry ingredients - acid, salts, and color(s) |
| 3 | Mix all liquid ingredients (puree blend, juice concentrate, |
| | flavors, oil and water) |
| 4 | Combine dry powder from step 1 and liquid blend from step 3 |
| | using high sheer mixer |
| 5 | Heat to 175-200 F. (altitude dependent), stir |
| 6 | Add dry blend from step 2 and blend well |
| 7 | Immediately deposit into molds about 180° F., de-mold |
| | after gel is set up. |
| | Alternatively, deposit straight into packaging (examples |
| | include: plastic tray, stick pack, sachet or pouch). |
| 8 | Seal packaging while still hot about 180° F. |
| 9 | Cool to room temperature - 30-60 minutes |

It is to be noted that after gelation, the composition is in the form of a dimensionally stable shape and has a water content of greater than or equal about 85 wt %, preferably greater than or equal to about 90 wt %, based on the gelled composition.

This material is advantageous because it displays the following properties. It is high in moisture content; in solid form with a homogenous texture; the product is a soft gel with a chewy, gummy-like texture; is soft and can be eaten without chewing for those with limited chewing ability/jaw strength; the product does not contain added sugar; the product does not have an artificial taste typical of low sugar products; the product is lower in sugar than traditional gummy confectionery (e.g., Haribo gummies) and is also lower in sugar than other soft jellies (e.g., Jell-o); the product facilitates delivery of many actives, nutraceutical and nutritional ingredients; no chemical (artificial) preservatives are added; it does not contain GMO (BE) ingredients; the colors are from plant extracts; the product does not contain artificial flavors; the product is keto-friendly; the product is free from major allergens and is plant-based and vegan; the product can be frozen or refrigerated for a cool, refreshing experience and the texture/mouthfeel/sensory will be different dependent on temperature; and the product is easy to carry, store and ready to eat.

In an embodiment, the composition is in a solid form, through the entire cross-sectional area. There is no liquid center or gushing despite the high water holding capacity (greater than or equal to about 90 wt %) of the composition. The composition suffers no syneresis—i.e., no contraction of the composition accompanied by the separating out of liquid (water). The composition is shelf stable at ambient temperature for extended periods of time (e.g., greater than 3 months, preferably greater than 6 months, and more preferably greater than 9 months). The composition is not degraded or contaminated by microbes for a period of greater than 6 months, preferably greater than 12 months and more preferably greater than 18 months. Optionally, the composition can treated and enveloped with modified atmosphere packaging, such as nitrogen flushing and/or a composition to minimize degradation and decomposition.

### Example 2

This example was conducted to demonstrate the properties of some of the compositions after being compounded. In this example, rupture force and texture profile analysis (TPA) were conducted on samples containing fruit puree. The fruit puree comprises mango, tangerine, apple and lemon in a total amount of 10 wt %, based on the weight of the composition prior to processing. The water is present initially in an amount of 80 wt %, based on the weight of the composition prior to processing. The amount of gel is 1.5 wt %, based on the weight of the composition prior to processing. The remainder is juice concentrate.

The ingredients are mixed at 180° F. for approximately 30 minutes. The mixing was conducted as in Table 2.

The gel samples were cut to 1-inch×1-inch pieces and placed in a sample holder. The testing temperature was 77° F. A texture analyzer (TA.XTplusC, Stable Micro Systems, Texture Technologies Corp. MA, US) and a 1 cm² Kobe Probe was used for texture profile analysis (TPA) with the following settings:

### First Set of Testing Parameters

| Test mode | Compression | |
|---|---|---|
| Pre-Test Speed | 2.00 millimeters per second (mm/sec) | |
| Test Speed | 1.00 | mm/sec |
| Post-Test Speed | 2.00 | mm/sec |
| Target Mode | Distance | |
| Distance | 5.00 | mm |

| | |
|---|---|
| Trigger Force | 5.0 grams (g) |
| Time between two compressions | 30 seconds (s) |

### Second Set of Testing Parameters

Gel burst strength/rupture force was analyzed with the following settings:

| Test mode | Measure Force in Compression | |
|---|---|---|
| Pre-Test Speed | 1.00 | mm/sec |
| Test Speed | 2.00 | mm/sec |
| Post-Test Speed | 10.00 | mm/sec |
| Target Mode | Distance | |
| Distance | 8.00 | mm |
| Trigger Force | 3.0 | g |

The first set of testing parameters were used to determine resilience, cohesion, springiness, gumminess, and the second set of testing parameters were used to determine gel strength and rupture force/stress. The results are shown in Table 3 below.

TABLE 3

| | MEAN | STDEV |
|---|---|---|
| Gel Strength (unit: g) | 327.1 | 55.502 |
| Resilience (unit: %) | 21.5 | 5.000 |
| Cohesion (unit: %) | 42.2 | 7.686 |
| Springiness (unit: %) | 41.4 | 10.558 |
| Gumminess | 13782.6 | 3342.462 |
| Rupture force/stress (unit: g/cm2) | 482.6 | 102.104 |

The hydration composition has a gel strength that varies from 175 to 500 grams, a resilience that varies from 5 to 45 percent, a cohesion that varies from 18 to 60 percent, a springiness that varies from 18 to 65 percent, a gumminess that varies from 7,500 to 23,000, and a rupture stress that varies from 375 to 980 gram/centimeter².

### Example 3

This example was conducted to determine the moisture content on a sample containing apple puree in an amount of less that 9 wt %. The test was conducted for samples using AOAC Official Method 950.46 after processing as detailed in Table 2. The moisture content was 91.2 wt % for both samples.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A hydration composition comprising:
water;
a gelling agent; and
fruit or vegetable puree having a particle size of 50 nanometers to 0.5 millimeters and/or fruit or vegetable particles having a particle size of 4 millimeters to 15 millimeters.

2. The hydration composition of claim 1, wherein the water is present in an amount of greater than 90% wt %, based on the weight of a gelled composition; where the gelled composition comprises heating and mixing the hydration composition.

3. The hydration composition of claim 1, wherein the water is present in an amount of greater than 95 wt %, based on the weight of the hydration composition prior to mixing.

4. The hydration composition of claim 1, further comprising a fruit juice, concentrate, or honey.

5. The hydration composition of claim 1, wherein the gelling agent is present in an amount of 0.5 to 3 wt %, based on the weight of the hydration composition.

6. The hydration composition of claim 1, wherein the gelling agent comprises a mixture of konjac, xanthan and pectin.

7. The hydration composition of claim 1, wherein the hydration composition further comprises a soluble fiber.

8. The hydration composition of claim 1, wherein the hydration composition further comprises at least one of electrolytes, proteins, nutrients, vitamins, prebiotics, probiotics, caffeine, nootropics, adaptogens, pharmaceuticals and biologically active agents, or a combination thereof.

9. The hydration composition of claim 1, wherein the puree is derived from fruit comprising mangoes, guava, peaches, berries (strawberries, blackberries, blueberries, raspberries, cranberries, elderberries, chokecherries, chokeberries, and the like), pineapples, watermelon, bananas, citrus (orange, lemon, lime, yuzu, and the like), melon (watermelon, cantaloupe, honey dew, and the like), cherries, banana, pineapple, pears, apples, grapes, coconuts, avocados, acai, figs, lychee, dates, camu, mangosteen, yuzu, pomegranate, and jujube.

10. The hydration composition of claim 1, wherein the puree is derived from vegetable comprising cucumber, sweet potato, butternut squash, potato, carrot, pumpkin, spinach, kale, broccoli, beets, bok choy, cauliflower, peas, zucchini, legumes, or a combination thereof.

11. The hydration composition of claim 2, wherein the gelled composition has a pH of 2 to 9.

12. The hydration composition of claim 8, where the electrolytes are concentrated on the fruit and/or vegetable puree having a particle size of 50 nanometers to 0.5 millimeters and/or fruit or vegetable particles or particles.

13. The hydration composition of claim 1, where the hydration composition has a gel strength that varies from 175 to 500 grams, a resilience that varies from 5 to 45 percent, cohesion varies from 18 to 60 percent, a springiness that varies from 18 to 65 percent, a gumminess that varies from 7,500 to 23,000, and a rupture stress that varies from 375 to 980 gram/centimeter².

14. The hydration composition of claim 1, where the hydration composition comprises a coating of a functional ingredient and/or a flavorant.

15. A method comprising:
mixing together a hydration composition comprising water; a gelling agent; and fruit or vegetable puree having a particle size of 50 nanometers to 0.5 millimeters and/or fruit or vegetable particles having a particle size of 4 millimeters to 15 millimeters; and
gelling the hydration composition to form a gelled composition.

16. The method of claim 15, wherein the mixing is conducted at a temperature greater than room temperature.

17. The method of claim 15, further comprising adding at least one of a soluble fiber, insoluble fibers, electrolytes, proteins, nutrients, vitamins, prebiotics, probiotics, caffeine, nootropics, adaptogens, pharmaceuticals and biologically active agents to the hydration composition.

18. The method of claim 17, where the electrolytes are concentrated on the fruit and/or vegetable puree having a particle size of 50 nanometers to 0.5 millimeters and/or fruit or vegetable particles have a particle size of 4 millimeters to 15 millimeters.

19. The method of claim 15, where the hydration composition where the hydration composition has a gel strength that varies from 175 to 500 grams, a resilience that varies from 5 to 45 percent, cohesion varies from 18 to 60 percent, a springiness that varies from 18 to 65 percent, a gumminess that varies from 7,500 to 23,000, and a rupture stress that varies from 375 to 980 gram/centimeter².

20. The method of claim 15, further comprising adding a coating that comprises a functional ingredient and/or a flavorant to an outer surface of the hydration composition.
